(19) United States
(12) Patent Application Publication
(10) Pub. No.: US 2025/0373666 A1
(43) Pub. Date: Dec. 4, 2025

(54) SYSTEMS AND METHODS FOR AUTOMATED HYPOTHESIS GENERATION

(71) Applicant: BeeKeeperAI, Inc., Austin, TX (US)

(72) Inventors: Sudish Mogli, San Jose, CA (US); Syam Malampati, Antioch, CA (US); Alan Czeszynski, Pleasanton, CA (US); Pavan Gupta, Oakland, CA (US); Michael Scott Blum, Austin, TX (US); Robert Derward Rogers, Oakland, CA (US)

(21) Appl. No.: 19/248,142

(22) Filed: Jun. 24, 2025

Related U.S. Application Data
(63) Continuation-in-part of application No. 19/224,939, filed on Jun. 2, 2025.
(60) Provisional application No. 63/655,063, filed on Jun. 2, 2024.

(51) Int. Cl. H04L 9/40

(52) U.S. Cl. CPC H04L 63/20; H04L 63/0428

(57) ABSTRACT

Systems and methods related to the generation of a hypothesis is presented. First a user inputs at least one research paper or study. The at least one research paper or study is mined by an AI algorithm for a set of data requirements. The set of data requirements may be combined with a tailored prompt into a generative AI system to generate a data specification. Next, within a secure enclave, the data specification may be combined with natural language (NL) prompts to interrogate data sets from a plurality of data stewards. A data set from the interrogated data sets that meets the data specification is selected. The data set is then encrypted, used to generate and train an AI model.

### CROSS REFERENCE TO RELATED APPLICATIONS

This application is a continuation in part and claims the benefit of U.S. non-provisional application Ser. No. 19/224,939 filed Jun. 2, 2025 entitled “SYSTEMS AND METHODS FOR DYNAMIC POLICY GENERATION AND COMPLIANCE IN A TRUSTED COMPUTING ENVIRONMENT”, which is a non-provisional of and claims the benefit of U.S. Provisional Application No. 63/655,063 filed Jun. 2, 2024 entitled “SYSTEMS AND METHODS FOR DYNAMIC POLICY GENERATION AND COMPLIANCE IN A TRUSTED COMPUTING ENVIRONMENT”, the contents of which are incorporated in their entirety by this reference.

### BACKGROUND

The present invention relates in general to the field of confidential computing, and more specifically to methods, computer programs and systems for the automated generation of a hypothesis and ultimately for model generation and validation. Such systems and methods are particularly useful for converting an input into an actionable model in a secure and zero trust manner.

Within certain fields, there is a distinguishment between the developers of algorithms (often machine learning of artificial intelligence algorithms), and the stewards of the data that said algorithms are intended to operate with and be trained by. For the avoidance of doubt, an algorithm may include a model, code, pseudo-code, source code, or the like. On its surface, this seems to be an easily solved problem of merely sharing either the algorithm or the data that it is intended to operate with. However, in reality, there is often a strong need to keep the data and the algorithm secret. For example, the companies developing their algorithms may have the bulk of their intellectual property tied into the software comprising the algorithm. For many of these companies, their entire value may be centered in their proprietary algorithms. Sharing such sensitive data is a real risk to these companies, as the leakage of the software base code could eliminate their competitive advantage overnight.

One could imagine that instead, the data could be provided to the algorithm developer for running their proprietary algorithms and generation of the attendant reports. However, the problem with this methodology is two-fold. Firstly, the datasets for processing are often extremely large, requiring significant time to transfer the data from the data steward to the algorithm developer. Indeed, sometimes the datasets involved consume petabytes of data. The fastest fiber optics internet speed in the US is 2,000 MB/second. At this speed, transferring a petabyte of data can take nearly seven days to complete. It should be noted that most commercial internet speeds are a fraction of this maximum fiber optic speed.

The second reason that the datasets are not readily shared with the algorithm developers is that the data itself may be secret in some manner. For example, the data could also be proprietary, being of a significant asset value. Moreover, the data may be subject to some controls or regulations. This is particularly true in the case of medical information. Protected health information, or PHI, for example, is subject to a myriad of laws, such as HIPAA and GDPR, that include strict requirements on the sharing of PHI, and are subject to significant fines if such requirements are not adhered to.

Healthcare related information is of particular focus in this application. Of all the global stored data, about 30% resides in healthcare. This data provides a treasure trove of information for algorithm developers to train their specific algorithm models (AI or otherwise) and allows for the identification of correlations and associations within datasets. Such data processing allows advancements in the identification of individual pathologies, public health trends, treatment success metrics, and the like. Such output data from the running of these algorithms may be invaluable to individual clinicians, healthcare institutions, and private companies (such as pharmaceutical and biotechnology companies). At the same time, the adoption of clinical AI has been slow. Data access is a major barrier to clinical approval. The FDA requires proof that a model works across the entire population. However, privacy protections make it challenging to access enough diverse data to accomplish this goal.

As such, it is often very difficult to generate an algorithm without access to the underlying data, making typical algorithm development an arduous process that requires significant expertise.

Given that there is great value in the ability to generate algorithms quickly and without significant developer expertise in an environment where the data is not readily available to the algorithm developer, systems and methods automated hypothesis generation are provided.

### SUMMARY

The present systems and methods relate to automated hypothesis generation. These systems and methods enable the system to be fed an input that is in turn converted into a hypothesis and a data specification for automated model generation, training and validation. Such systems provide the ability to rapidly convert an input into a functioning algorithm without the need for significant user input or expertise.

In some embodiments, first a user inputs at least one research paper or study. The at least one research paper or study is mined by an AI algorithm for a set of data requirements. The set of data requirements may be combined with a tailored prompt into a generative AI system to generate a data specification. Next, within a secure enclave, the data specification may be combined with natural language (NL) prompts to interrogate data sets from a plurality of data stewards. A data set from the interrogated data sets that meets the data specification is selected. The data set is then encrypted, used to generate and train an AI model.

The AI model is generated by feeding a hypothesis into a model proposal engine to supply base model options. Further, the base model and the data set are then merged in a trusted execution environment to train the model. The trained AI model is then output to a core management system for registration. The trained AI model is also tested for exfiltration risks. The trained AI model is also validated by creating a policy using a sample output report and prompts using a generative AI large language model (LLM) to generate a set of validation criteria. Reserve data was generated back when the data set was being constructed. This reserve data is used with the trained AI model to check for data leakage and for generating an output report.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A and 1B are example block diagrams of a system for zero trust computing of data by an algorithm, in accordance with some embodiment;

FIG. 2 is an example block diagram showing the core management system, in accordance with some embodiment;

FIG. 3 is an example block diagram showing an example model for the confidential computing data flow, in accordance with some embodiment;

FIG. 4 is a flowchart for an example process for the operation of the confidential computing data processing system, in accordance with some embodiment;

FIG. 5 a flowchart for an example process of acquiring and curating data, in accordance with some embodiment;

FIG. 6 a flowchart for an example process of onboarding a new host data steward, in accordance with some embodiment;

FIG. 7 is a flowchart for an example process of encapsulating the algorithm and data, in accordance with some embodiment;

FIG. 8 is a flowchart for an example process of algorithm encryption and handling, in accordance with some embodiment;

FIG. 9 is an example block diagram showing a trusted computing environment with hypothesis generation, in accordance with some embodiment;

FIG. 10 is a flow diagram an example process of hypothesis generation, in accordance with some embodiment;

FIG. 11 is a flowchart for an example process of model generation, in accordance with some embodiment;

FIG. 12 is a flowchart for an example process of validation, in accordance with some embodiment; and

FIGS. 13A and 13B are illustrations of computer systems capable of implementing the confidential computing, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for the confidential computing application on one or more algorithms processing sensitive datasets. Such systems and methods may be applied to any given dataset, but may have particular utility within the healthcare setting, where the data is extremely sensitive. As such, the following descriptions will center on healthcare use cases. This particular focus, however, should not artificially limit the scope of the invention. For example, the information processed may include sensitive industry information, financial, payroll or other personally identifiable information, or the like. As such, while much of the disclosure will refer to protected health information (PHI) it should be understood that this may actually refer to any sensitive type of data. Likewise, while the data stewards are generally thought to be a hospital or other healthcare entity, these data stewards may in reality be any entity that has and wishes to process their data within a zero-trust environment.

In some embodiments, the following disclosure will focus upon the term “algorithm”. It should be understood that an algorithm may include machine learning (ML) models, neural network models, or other artificial intelligence (AI) models. However, algorithms may also apply to more mundane model types, such as linear models, least mean squares, or any other mathematical functions that convert one or more input values, and results in one or more output models.

Also, in some embodiments of the disclosure, the terms “node”, “infrastructure” and “enclave” may be utilized. These terms are intended to be used interchangeably and indicate a computing architecture that is logically distinct (and often physically isolated). In no way does the utilization of one such term limit the scope of the disclosure, and these terms should be read interchangeably.

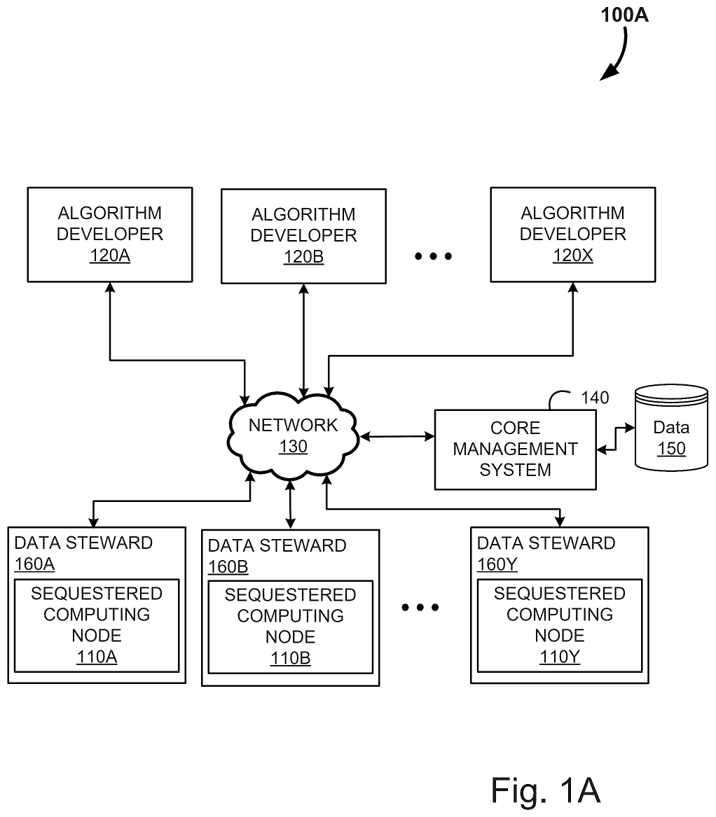

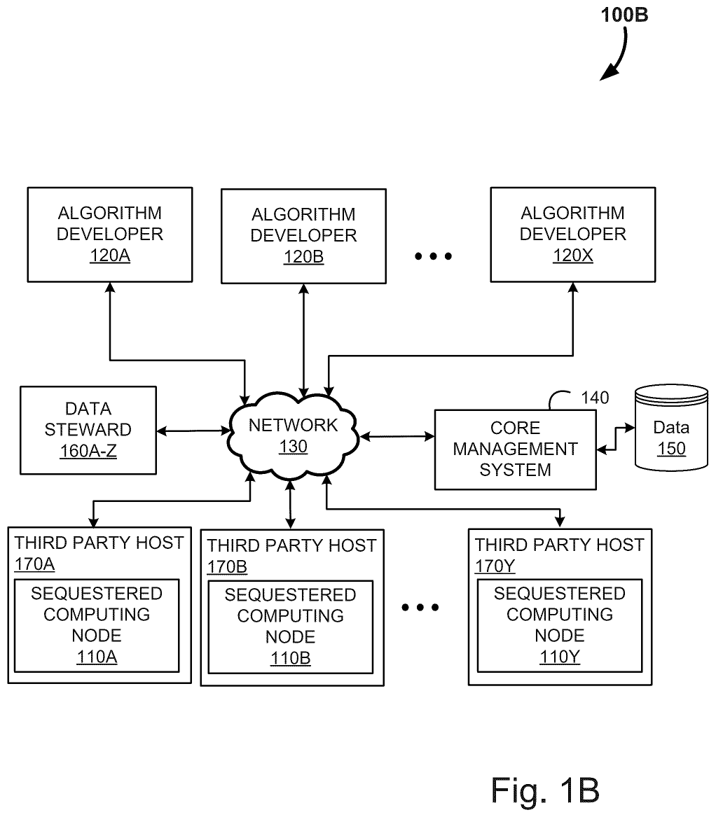

To facilitate discussions, FIG. 1A is an example of a confidential computing infrastructure, shown generally at 100a. This infrastructure includes one or more algorithm developers 120a-x which generate one or more algorithms for processing of data, which in this case is held by one or more data stewards 160a-y. The algorithm developers are generally companies that specialize in data analysis, and are often highly specialized in the types of data that are applicable to their given models/algorithms. However, sometimes the algorithm developers may be individuals, universities, government agencies, or the like. By uncovering powerful insights in vast amounts of information, AI and machine learning (ML) can improve care, increase efficiency, and reduce costs. For example, AI analysis of chest x-rays predicted the progression of critical illness in COVID-19. In another example, an image-based deep learning model developed at MIT can predict breast cancer up to five years in advance. And yet another example is an algorithm developed at University of California San Francisco, which can detect pneumothorax (collapsed lung) from CT scans, helping prioritize and treat patients with this life-threatening condition—the first algorithm embedded in a medical device to achieve FDA approval.

Likewise, the data stewards may include public and private hospitals, companies, universities, banks and other financial institutions, governmental agencies, or the like. Indeed, virtually any entity with access to sensitive data that is to be analyzed may be a data steward.

The generated algorithms are encrypted at the algorithm developer in whole, or in part, before transmitting to the data stewards, in this example ecosystem. The algorithms are transferred via a core management system 140, which may supplement or transform the data using a localized datastore 150. The core management system also handles routing and deployment of the algorithms. The datastore may also be leveraged for key management in some embodiments that will be discussed in greater detail below.

Each of the algorithm developer 120a-x, and the data stewards 160a-y and the core management system 140 may be coupled together by a network 130. In most cases the network is comprised of a cellular network and/or the internet. However, it is envisioned that the network includes any wide area network (WAN) architecture, including private WAN's, or private local area networks (LANs) in conjunction with private or public WANs.

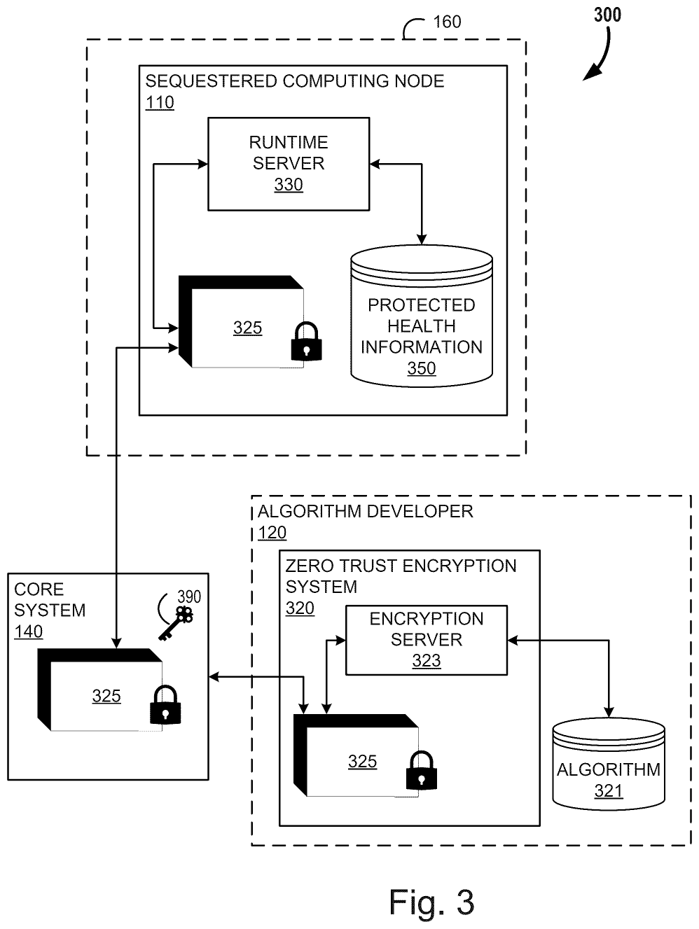

In this particular system, the data stewards maintain sequestered computing nodes 110a-y which function to actually perform the computation of the algorithm on the dataset. The sequestered computing nodes, or “enclaves”, may be physically separate computer server systems, or may encompass virtual machines operating within a greater network of the data steward's systems. The sequestered computing nodes should be thought of as a vault. The encrypted algorithm and encrypted datasets are supplied to the vault, which is then sealed. Encryption keys 390, as seen in FIG. 3, unique to the vault are then provided, which allows the decryption of the data and models to occur. No party has access to the vault at this time, and the algorithm is able to securely operate on the data. The data and algorithms may then be destroyed, or maintained as encrypted, when the vault is “opened” in order to access the report/output derived from the application of the algorithm on the dataset. Due to the specific sequestered computing node being required to decrypt the given algorithm(s) and data, there is no way they can be intercepted and decrypted. This system relies upon public-private key techniques, where the algorithm developer utilizes the public key 390 for encryption of the algorithm, and the sequestered computing node includes the private key in order to perform the decryption. In some embodiments, the private key may be hardware (in the case of Azure, for example) or software linked (in the case of AWS, for example). In other embodiments, the algorithm may be encrypted using a symmetric key, and the symmetric key may be wrapped encrypted by a public key. Specifically, the algorithm developer has their own symmetrical key (content encryption key) used to encrypt the algorithm. The algorithm developer uses the public key to encrypt or “wrap” the content encryption key. The unwrapping occurs in the vault using the private half of the key, to then enable the content encryption key to decrypt the algorithm.

In some particular embodiments, the system sends algorithm models via an Azure Confidential Computing environment to a data steward's environment. Upon verification, the model and the data entered the Intel SGX sequestered enclave where the model is able to be validated against the protected information, for example PHI, data sets. Throughout the process, the algorithm owner cannot see the data, the data steward cannot see the algorithm model, and the management core can see neither the data nor the model. It should be noted that an Intel SGX enclave is but one substantiation of a hardware enabled trusted execution environment. Other hardware and/or software enabled trusted execution environments may be readily employed in other embodiments.

The data steward uploads encrypted data to their cloud environment using an encrypted connection that terminates inside an Intel SGX-sequestered enclave. In some embodiments, the encrypted data may go into Blob storage prior to terminus in the sequestered enclave, where it is pulled upon as needed. Then, the algorithm developer submits an encrypted, containerized AI model which also terminates into an Intel SGX-sequestered enclave. In some specific embodiments, a key management system in the management core enables the containers to authenticate and then run the model on the data within the enclave. In alternate embodiments, where distributed keys are utilized, there is no need for a key management system. Rather in such embodiments, the system is fully distributed among the parties, as shall be described in greater detail below. The data steward never sees the algorithm inside the container and the data is never visible to the algorithm developer. Neither component leaves the enclave. After the model runs, in some embodiments the developer receives a performance report on the values of the algorithm's performance. Finally, the algorithm owner may request that an encrypted artifact containing information about validation results is stored for regulatory compliance purposes and the data and the algorithm are wiped from the system.

FIG. 1B provides a similar ecosystem 100b. This ecosystem also includes one or more algorithm developers 120a-x, which generate, encrypt and output their models. The core management system 140 receives these encrypted payloads, and in some embodiments, transforms or augments unencrypted portions of the payloads. The major difference between this substantiation and the prior figure, is that the sequestered computing node(s) 110a-y are present within a third-party host 170a-y. An example of a third-party host may include an offsite server such as Amazon Web Service (AWS) or similar cloud infrastructure. Other examples can include any network-connected environment, such as traditional data centers. In such situations, the data steward encrypts their dataset(s) and provides them, via the network, to the third party hosted sequestered computing node(s) 110a-y. The output of the algorithm running on the dataset is then transferred from the sequestered computing node in the third-party, back via the network to the data steward (or potentially some other recipient).

In some specific embodiments, the system relies on a unique combination of software and hardware available through Azure Confidential Computing. The solution uses virtual machines (VMs) running on specialized Intel processors with Intel Software Guard Extension (SGX), in this embodiment, running in the third-party system. Intel SGX creates sequestered portions of the hardware's processor and memory known as “enclaves” making it impossible to view data or code inside the enclave. Software within the management core handles encryption, key management, and workflows.

In some embodiments, the system may be some hybrid between FIGS. 1A and 1B. For example, some datasets may be processed at local sequestered computing nodes, especially extremely large datasets, and others may be processed at third parties. Such systems provide flexibility based upon computational infrastructure, while still ensuring all data and algorithms remain sequestered and not visible except to their respective owners.

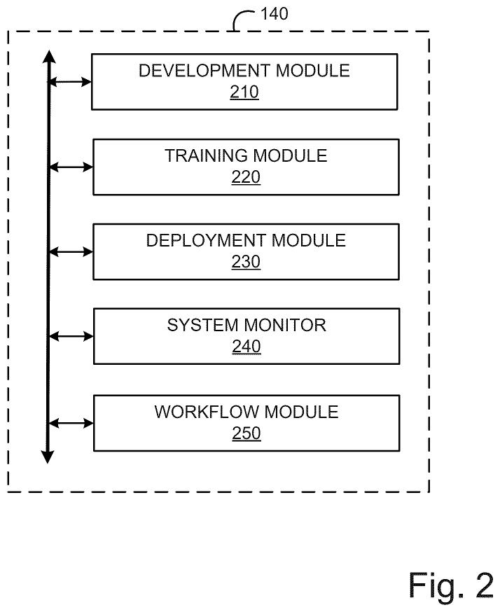

Turning now to FIG. 2, greater detail is provided regarding the core management system 140. The core management system 140 may include a data science development module 210, a data harmonizer workflow creation module 250, a software deployment module 230, a federated master algorithm training module 220, a system monitoring module 240, and a data store comprising global join data 240.

The data science development module 210 may be configured to receive input data requirements from the one or more algorithm developers for the optimization and/or validation of the one or more models. The input data requirements define the objective for data curation, data transformation, and data harmonization workflows. The input data requirements also provide constraints for identifying data assets acceptable for use with the one or more models. The data harmonizer workflow creation module 250 may be configured to manage transformation, harmonization, and annotation protocol development and deployment. The software deployment module 230 may be configured along with the data science development module 210 and the data harmonizer workflow creation module 250 to assess data assets for use with one or more models. This process can be automated or can be an interactive search/query process. The software deployment module 230 may be further configured along with the data science development module 210 to integrate the models into a sequestered capsule computing framework, along with required libraries and resources.

In some embodiments, it is desired to develop a robust, superior algorithm/model that has learned from multiple disjoint private data sets (e.g., clinical and health data) collected by data hosts from sources (e.g., patients). The federated master algorithm training module may be configured to aggregate the learning from the disjoint data sets into a single master algorithm. In different embodiments, the algorithmic methodology for the federated training may be different. For example, sharing of model parameters, ensemble learning, parent-teacher learning on shared data and many other methods may be developed to allow for federated training. The privacy and security requirements, along with commercial considerations such as the determination of how much each data system might be paid for access to data, may determine which federated training methodology is used.

The system monitoring module 240 monitors activity in sequestered computing nodes. Monitored activity can range from operational tracking such as computing workload, error state, and connection status as examples to data science monitoring such as amount of data processed, algorithm convergence status, variations in data characteristics, data errors, algorithm/model performance metrics, and a host of additional metrics, as required by each use case and embodiment.

In some instances, it is desirable to augment private data sets with additional data located at the core management system (join data 150). For example, geolocation air quality data could be joined with geolocation data of patients to ascertain environmental exposures. In certain instances, join data may be transmitted to sequestered computing nodes to be joined with their proprietary datasets during data harmonization or computation.

The sequestered computing nodes may include a harmonizer workflow module 250, harmonized data, a runtime server, a system monitoring module, and a data management module (not shown). The transformation, harmonization, and annotation workflows managed by the data harmonizer workflow creation module may be deployed by and performed in the environment by harmonizer workflow module using transformations and harmonized data. In some instances, the join data may be transmitted to the harmonizer workflow module to be joined with data during data harmonization. The runtime server may be configured to run the private data sets through the algorithm/model.

The system monitoring module monitors activity in the sequestered computing node. Monitored activity may include operational tracking such as algorithm/model intake, workflow configuration, and data host onboarding, as required by each use case and embodiment. The data management module may be configured to import data assets such as private data sets while maintaining the data assets within the pre-exiting infrastructure of the data stewards.

Turning now to FIG. 3, an example of the flow of algorithms and data are provided, generally at 300. The Zero-Trust Encryption System 320 manages the encryption, by an encryption server 323, of all the algorithm developer's 120 software assets 321 in such a way as to prevent exposure of intellectual property (including source or object code) to any outside party, including the entity running the core management system 140 and any affiliates, during storage, transmission and runtime of said encrypted algorithms 325. In this embodiment, the algorithm developer is responsible for encrypting the entire payload 325 of the software using its own encryption keys. Decryption is only ever allowed at runtime in a sequestered capsule computing environment 110.

The core management system 140 receives the encrypted computing assets (algorithms) 325 from the algorithm developer 120. Decryption keys to these assets are not made available to the core management system 140 so that sensitive materials are never visible to it. The core management system 140 distributes these assets 325 to a multitude of data steward nodes 160 where they can be processed further, in combination with private datasets, such as protected health information (PHI) 350.

Each Data Steward Node 160 maintains a sequestered computing node 110 that is responsible for allowing the algorithm developer's encrypted software assets 325 (the “algorithm” or “algo”) to compute on a local private dataset 350 that is initially encrypted. Within data steward node 160, one or more local private datasets (not illustrated) is harmonized, transformed, and/or annotated and then this dataset is encrypted by the data steward, into a local dataset 350, for use inside the sequestered computing node 110.

The sequestered computing node 110 receives the encrypted software assets 325 and encrypted data steward dataset(s) 350 and manages their decryption in a way that prevents visibility to any data or code at runtime at the runtime server 330. In different embodiments this can be performed using a variety of secure computing enclave technologies, including but not limited to hardware-based and software-based isolation.

In this present embodiment, the entire algorithm developer software asset payload 325 is encrypted in a way that it can only be decrypted in an approved sequestered computing enclave/node 110. This approach works for sequestered enclave technologies that do not require modification of source code or runtime environments in order to secure the computing space (e.g., software-based secure computing enclaves).

The Algorithm developer 120 generates an algorithm, which is then encrypted and provided as an encrypted algorithm payload 325 to the core management system 140. As discussed previously, the core management system 140 is incapable of decrypting the encrypted algorithm 325. Rather, the core management system 140 controls the routing of the encrypted algorithm 325 and the management of keys. The encrypted algorithm 325 is then provided to the data steward 160 which is then “placed” in the sequestered computing node 110. The data steward 160 is likewise unable to decrypt the encrypted algorithm 325 unless and until it is located within the sequestered computing node 110, in which case the data steward still lacks the ability to access the “inside” of the sequestered computing node 110. As such, the algorithm is never accessible to any entity outside of the algorithm developer.

Likewise, the data steward 160 has access to protected health information and/or other sensitive information. The data steward 160 never is required to transfer this data outside of its ecosystem (an if it is, it may remain in an encrypted state) thus ensuring that the data is always inaccessible by any other party by virtue of it remaining encrypted when accessible by any other party. The sensitive data may be encrypted (or remain in the clear) as it is also transferred into the sequestered computing node 110. This data store is made accessible to the runtime server 330 also located “inside” the sequestered computing node 110. The runtime server 330 decrypts the encrypted algorithm 325 to yield the underlying algorithm model. This algorithm may then use the data store to generate inferences regarding the date contained in the data store (not illustrated). These inferences have value for the data steward 110 as well as other interested parties and may be outputted to the data steward (or other interested parties such as researchers or regulators) for consumption. The runtime server 330 may likewise engage in training activities.

The runtime server 330 may also perform a number of other operations, such as the generation of a performance model or the like. The performance model is a regression model generated based upon the inferences derived from the algorithm. The performance model provides data regarding the performance of the algorithm based upon the various inputs. The performance model may model for any of algorithm accuracy, F1 score, precision, recall, dice score, ROC (receiver operator characteristic) curve/area, log loss, Jaccard index, error, R², by some combination thereof, or by any other suitable metric.

Once the algorithm developer 120 receives the performance model it may be decrypted, and leveraged to validate the algorithm and, importantly, may be leveraged to actively train the algorithm in the future. This may occur by identifying regions of the performance model that have lower performance ratings and identify attributes/variables in the datasets that correspond to these poorer performing model segments. The system then incorporates human feedback when such variables are present in a dataset to assist in generating a gold standard training set for these variable combinations. The performance model may then be trained based upon these gold standard training sets. Even without the generation of additional gold standard data, investigation of poorer performing model segments enables changes to the functional form of the model and testing for better performance. It is likewise possible that the inclusion of additional variables by the model allows for the distinction of attributes of a patient population. This is identified by areas of the model that has a lower performance which indicates that there is a fundamental issue with the model. An example is that a model operates well (has higher performance) for male patients as compared to female patients. This may indicate that different model mechanics may be required for female patient populations.

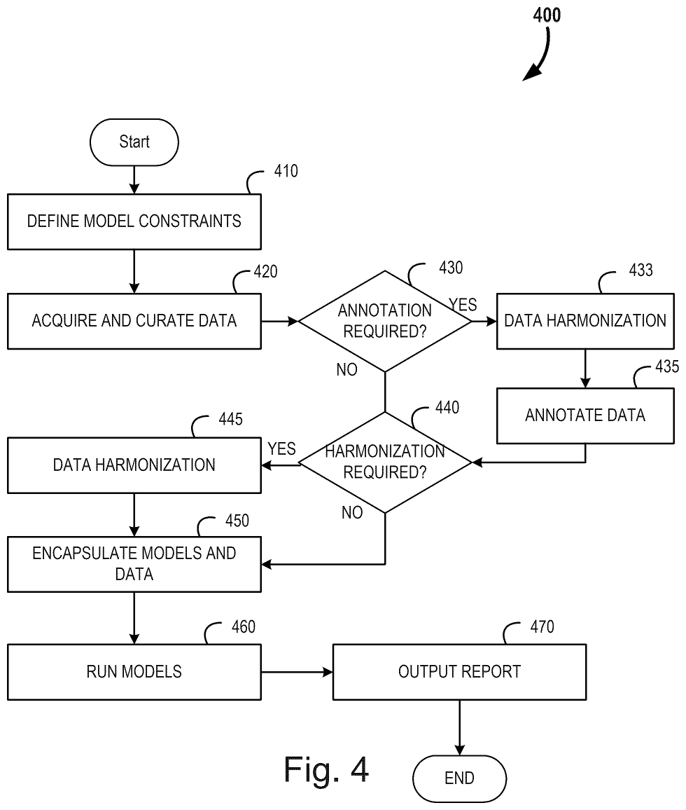

Turning to FIG. 4, one embodiment of the process for deployment and running of algorithms within the sequestered computing nodes is illustrated, at 400. Initially the algorithm developer provides the algorithm to the system using whatever process they locally employ. For example, at least one algorithm/model is generated by the algorithm developer using their own development environment, tools, and seed data sets (e.g., training/testing data sets). In some embodiments, the algorithms may be trained on external datasets instead, as will be discussed further below. The algorithm developer provides constraints (at 410) for the optimization and/or validation of the algorithm(s). Constraints may include any of the following: (i) training constraints, (ii) data preparation constraints, and (iii) validation constraints. These constraints define objectives for the optimization and/or validation of the algorithm(s) including data preparation (e.g., data curation, data transformation, data harmonization, and data annotation), model training, model validation, and reporting.

In some embodiments, the training constraints may include, but are not limited to, at least one of the following: hyperparameters, regularization criteria, convergence criteria, algorithm termination criteria, training/validation/test data splits defined for use in algorithm(s), and training/testing report requirements. A model hyper parameter is a configuration that is external to the model, and which value cannot be estimated from data. The hyperparameters are settings that may be tuned or optimized to control the behavior of a ML or AI algorithm and help estimate or learn model parameters.

Regularization constrains the coefficient estimates towards zero. This discourages the learning of a more complex model in order to avoid the risk of overfitting. Regularization, significantly reduces the variance of the model, without a substantial increase in its bias. The convergence criterion is used to verify the convergence of a sequence (e.g., the convergence of one or more weights after a number of iterations). The algorithm termination criteria define parameters to determine whether a model has achieved sufficient training. Because algorithm training is an iterative optimization process, the training algorithm may perform the following steps multiple times. In general, termination criteria may include performance objectives for the algorithm, typically defined as a minimum amount of performance improvement per iteration or set of iterations.

The training/testing report may include criteria that the algorithm developer has an interest in observing from the training, optimization, and/or testing of the one or more models. In some instances, the constraints for the metrics and criteria are selected to illustrate the performance of the models. For example, the metrics and criteria such as mean percentage error may provide information on bias, variance, and other errors that may occur when finalizing a model such as vanishing or exploding gradients. Bias is an error in the learning algorithm. When there is high bias, the learning algorithm is unable to learn relevant details in the data. Variance is an error in the learning algorithm, when the learning algorithm tries to over-learn from the dataset or tries to fit the training data as closely as possible. Further, common error metrics such as mean percentage error and R2 score are not always indicative of accuracy of a model, and thus the algorithm developer may want to define additional metrics and criteria for a more in depth look at accuracy of the model.

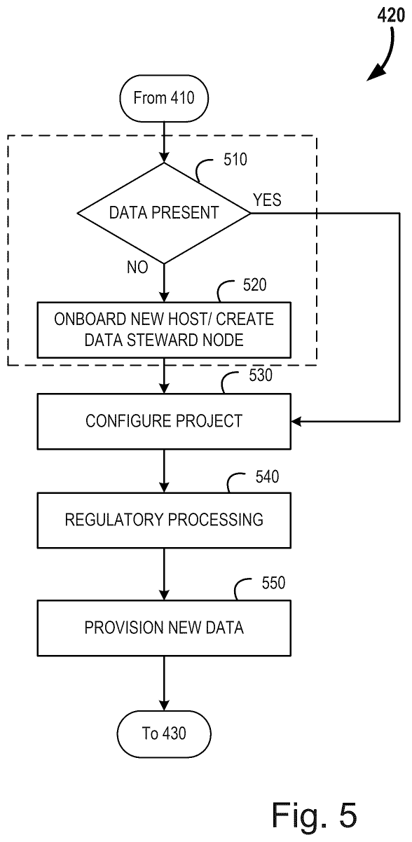

Next, data assets that will be subjected to the algorithm(s) are identified, acquired, and curated (at 420). FIG. 5 provides greater detail of this acquisition and curation of the data. Often, the data may include healthcare related data (PHI). Initially, there is a query if data is present (at 510). The identification process may be performed automatically by the platform running the queries for data assets (e.g., running queries on the provisioned data stores using the data indices) using the input data requirements as the search terms and/or filters. Alternatively, this process may be performed using an interactive process, for example, the algorithm developer may provide search terms and/or filters to the platform. The platform may formulate questions to obtain additional information, the algorithm developer may provide the additional information, and the platform may run queries for the data assets (e.g., running queries on databases of the one or more data hosts or web crawling to identify data hosts that may have data assets) using the search terms, filters, and/or additional information. In either instance, the identifying is performed using differential privacy for sharing information within the data assets by describing patterns of groups within the data assets while withholding private information about individuals in the data assets.

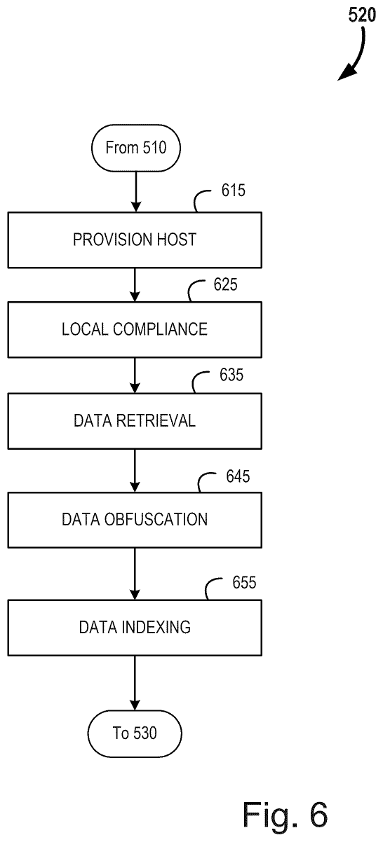

If the assets are not available, the process generates a new data steward node (at 520). The data query and onboarding activity (surrounded by a dotted line) is illustrated in this process flow of acquiring the data; however, it should be realized that these steps may be performed anytime prior to model and data encapsulation (step 450 in FIG. 6). Onboarding/creation of a new data steward node is shown in greater detail in relation to FIG. 6. In this example process a data host compute and storage infrastructure (e.g., a sequestered computing node as described with respect to FIGS. 1A-5) is provisioned (at 615) within the infrastructure of the data steward. In some instances, the provisioning includes deployment of encapsulated algorithms in the infrastructure, deployment of a physical computing device with appropriately provisioned hardware and software in the infrastructure, deployment of storage (physical data stores or cloud-based storage), or deployment on public or private cloud infrastructure accessible via the infrastructure, etc.

Next, governance and compliance requirements are performed (at 625). In some instances, the governance and compliance requirements includes getting clearance from an institutional review board, and/or review and approval of compliance of any project being performed by the platform and/or the platform itself under governing law such as the Health Insurance Portability and Accountability Act (HIPAA). Subsequently, the data assets that the data steward desires to be made available for optimization and/or validation of algorithm(s) are retrieved (at 635). In some instances, the data assets may be transferred from existing storage locations and formats to provisioned storage (physical data stores or cloud-based storage) for use by the sequestered computing node (curated into one or more data stores). The data assets may then be obfuscated (at 645). Data obfuscation is a process that includes data encryption or tokenization, as discussed in much greater detail below. Lastly, the data assets may be indexed (at 655). Data indexing allows queries to retrieve data from a database in an efficient manner. The indexes may be related to specific tables and may be comprised of one or more keys or values to be looked up in the index (e.g., the keys may be based on a data table's columns or rows).

Returning to FIG. 5, after the creation of the new data steward, the project may be configured (at 530). In some instances, the data steward computer and storage infrastructure is configured to handle a new project with the identified data assets. In some instances, the configuration is performed similarly to the process described of FIG. 6. Next, regulatory approvals (e.g., IRB and other data governance processes) are completed and documented (at 540). Lastly, the new data is provisioned (at 550). In some instances, the data storage provisioning includes identification and provisioning of a new logical data storage location, along with creation of an appropriate data storage and query structure.

Returning now to FIG. 4, after the data is acquired and configured, a query is performed if there is a need for data annotation (at 430). If so, the data is initially harmonized (at 433) and then annotated (at 435). Data harmonization is the process of collecting data sets of differing file formats, naming conventions, and columns, and transforming it into a cohesive data set. The annotation is performed by the data steward in the sequestered computing node. A key principle to the transformation and annotation processes is that the platform facilitates a variety of processes to apply and refine data cleaning and transformation algorithms, while preserving the privacy of the data assets, all without requiring data to be moved outside of the technical purview of the data steward.

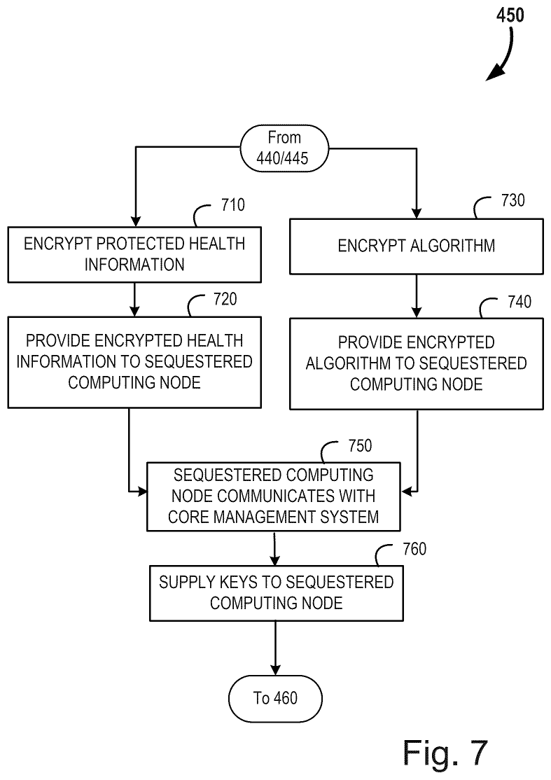

After annotation, or if annotation was not required, another query determines if additional data harmonization is needed (at 440). If so, then there is another harmonization step (at 445) that occurs in a manner similar to that disclosed above. After harmonization, or if harmonization isn't needed, the models and data are encapsulated (at 450). Data and model encapsulation is described in greater detail in relation to FIG. 7. In the encapsulation process the protected data, and the algorithm are each encrypted (at 710 and 730 respectively). In some embodiments, the data is encrypted either using traditional encryption algorithms (e.g., RSA) or homomorphic encryption.

Next the encrypted data and encrypted algorithm are provided to the sequestered computing node (at 720 and 740 respectively). There processes of encryption and providing the encrypted payloads to the sequestered computing nodes may be performed asynchronously, or in parallel. Subsequently, the sequestered computing node may phone home to the core management node (at 750) requesting the keys needed. These keys are then also supplied to the sequestered computing node (at 760), thereby allowing the decryption of the assets.

Returning again to FIG. 4, once the assets are all within the sequestered computing node, they may be decrypted and the algorithm may run against the dataset (at 460). The results from such runtime may be outputted as a report (at 470) for downstream consumption.

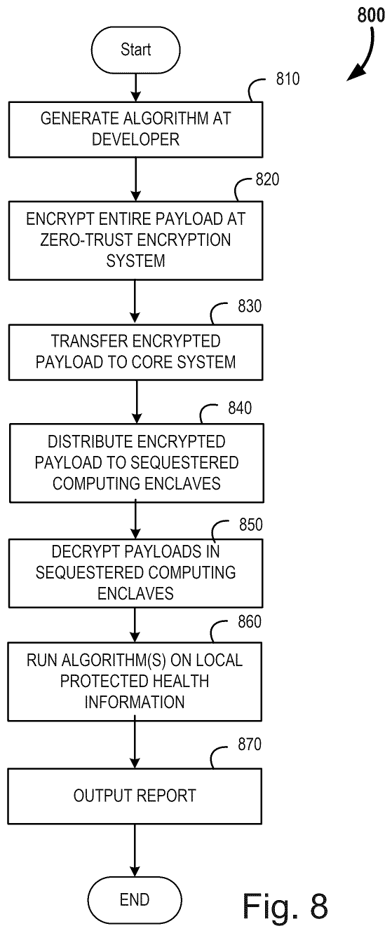

Turning now to FIG. 8, a first embodiment of the system for confidential computing processing of the data assets by the algorithm is provided, at 800. In this example process, the algorithm is initially generated by the algorithm developer (at 810) in a manner similar to that described previously. The entire algorithm, including its container, is then encrypted (at 820), using a public key, by the encryption server within the algorithm developer's infrastructure. The entire encrypted payload is provided to the core management system (at 830). The core management system then distributes the encrypted payload to the sequestered computing enclaves (at 840).

Likewise, the data steward collects the data assets desired for processing by the algorithm. This data is also provided to the sequestered computing node. In some embodiments, this data may also be encrypted. The sequestered computing node then contacts the core management system for the keys. The system relies upon public-private key methodologies for the decryption of the algorithm, and possibly the data (at 850).

After decryption within the sequestered computing node, the algorithm(s) are run (at 860) against the protected health information (or other sensitive information based upon the given use case). The results are then output (at 870) to the appropriate downstream audience (generally the data steward or algorithm developer, but may include public health agencies or other interested parties).

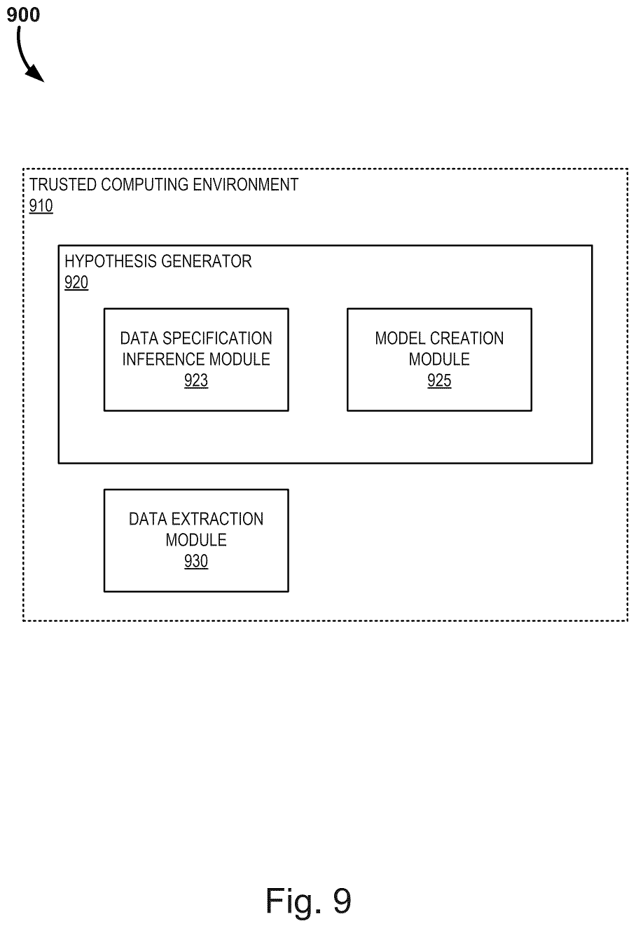

Turning now to FIG. 9, a block diagram 900 of a trusted computing environment 910 is provided. Within this trusted computing environment 910 are two primary components, a hypothesis generator 920 and a data extraction module 930. The hypothesis generator 920 includes tow subcomponents, a data specification inference module 923 and a model creation module 925.

The hypothesis generator 920 consumes input text, images, videos and audio materials to generate one or more hypotheses and associated data specs that apply to the generated hypotheses. A hypothesis is defined as an association between an activity and a data specification. The activity may be a specific analytical model or a proposed operational activity (e.g., clinical decision support, measurement activity, or the like).

Each hypothesis may generate a data specification that defines precisely what data is required to carry out the hypothesis. In some embodiments, a data specification may be generated independently from any hypothesis in order to facilitate preliminary investigations and hypothesis development. For example, the system may generate a data specification to understand availability and limitations of the present data in a data steward(s) environment(s). Outcome labels may be generated in association with a hypothesis. For example, in the analysis of longitudinal Electronic Health Records (EHR) data, label patients with incidence of heart attack, out-of-range lab, or other specific outcomes.

The model creation module 925 generates a specific AI, AI agent, ML model, analytical package or software module to carry out the activity defined in the hypothesis. For example, a computer vision model (and associated training pipeline) may be generated to identify an emergent medical condition in a chest x-ray.

The data specification inference module 923 generates the detailed data specification, inclusion and exclusion criteria, number counts and quality requirements that are needed to train, validate and deploy an activity. In some embodiments, the data specification inference module 923 may also generate desired outcome labels, when applicable. Inference may be performed directly on the input data (e.g., pulled from an appendix or supplement of a research paper), or may be assembled from automated or semi-automated internet research.

The data extraction module 930 generates tooling that assembles the data from a data steward, including quality measurement and cleaning, automated data labeling, cohort definition and objectives for total records to collect, and sampling strategy. The data extraction module 930 may be implemented as a traditional software tooling to extract data from files, tables or APIs. Alternatively, it may be implemented in a database query language such as SQL. It may also be implemented using proprietary tools that are related to the specific data sources being queried. Alternatively, it may be implemented using standards-based techniques such as OMOP, FHIR, HL7 or DICOM. Moreover, in yet another embodiment, it may be extracted and assembled using natural language tools, such as MCP.

The use of natural language tooling allows for a variety of flexible and broad strategies for identifying both structured and unstructured data that might be required by a data specification. For example, a natural language request for “patients with a diabetes diagnosis”, could be employed to automate retrieval of patients with a variety of ICD10 codes, CPT codes, lab values above specific scores, and the like.

The data extraction module 930 may also provide summaries of available data that conform to the data specification which may be validated. A validation module may leverage these summaries, which may be provided to the algorithm owner to assist with hypothesis refinement and project planning.

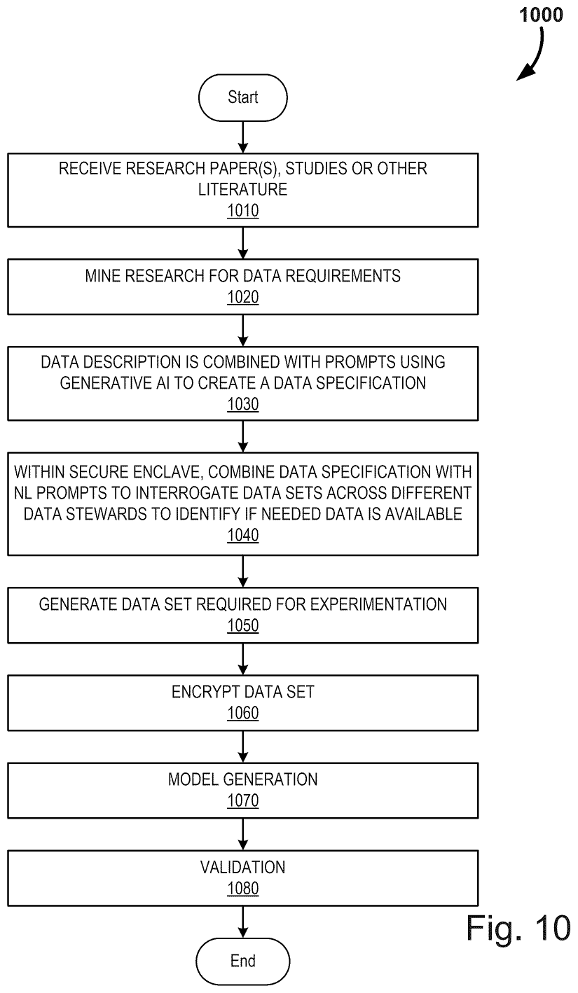

Moving on to FIG. 10, where a flow diagram 1000 is provided for the process of hypothesis generation. In this example process the system may be provided one or more research paper(s), studies, or other input materials, at 1010. These inputs may include audio and/or video files, written materials, images, and the like. Generally, the input materials are selected by a user for the insights that are uncovered, or the conclusions rendered by the input materials. Ideal input materials include well vetted, peer-reviewed research, which identifies a causal relationship or a correlation between some measurable metrics and a pathology (when involved in the healthcare field). The research paper may instead be in fields that are not healthcare related, in which case the conclusions may be field dependent. For example the paper/input may identify a relationship between leading indicators and economic outcomes in the financial field.

The input is supplied to a generative AI which extracts the conclusion that is tied back to a required data set. This relationship between the conclusion/activity and the data is the hypothesis that the general AI is able to extract from the input. The generative AI extracts not only the conclusion/activity but also the data needed to support the activity through a data mining workflow, at 1020. The data description is combined with prompts, in some embodiments, using the generative AI to create a data specification, at 1030. Prompts encompass both specific directions to the AI to define the task, the data, and the context of the problem, along with general instructions to the AI on how it should approach the problem. An example prompt could be, “You are an AI algorithm development assistant for medical device company CardioTechCo. Your goal is to identify new algorithms that are relevant to CardioTechCo's products A and B. Please review the attached research papers and identify algorithms to characterize risk for patients undergoing the product A procedure. Please create a data spec for this algorithm using ICD10, CPT and LOINC codes whenever possible, that can be used to generate training and validation data sets for this algorithm.”

Due to computational demands, the foregoing hypothesis generation and data specification activities may be performed in the clear, or in a minimally secured environment, due to the fact that private health data has yet to be introduced. The input is typically already public information, and the model outputs, while sensitive, do not require processing within a secure enclave. However, once the data specification has been developed, the next steps in the process are performed within a secure enclave to enable interrogation of sensitive datasets. Particularly, the data specification may be combined with natural language prompts to interrogate data sets across different data stewards to identify if the needed data is actually available, at 1040. In some embodiments, the natural language prompt is converted to code based query using Model Context Protocol (MCP) to interrogate the data in whichever form it exists. An MCP server generates the necessary output for the interrogation. The output of such an interrogation is a summary of the identified data set(s) (e.g., on the fly cohort generation). A set of training data may be built, as well as a reserve data set. The reserve data set may be utilized in later steps for model validation, as will be discussed in greater detail below.

The MCP server may also, after potential iteration, refine a cohort for the hypothesis, and the prompt is modified to include the creation of the data set needed for experimentation, at 1050. This data set is then saved back to the data steward's data store in an encrypted state, at 1060. The data specification is automatically updates with the latest version of the data table.

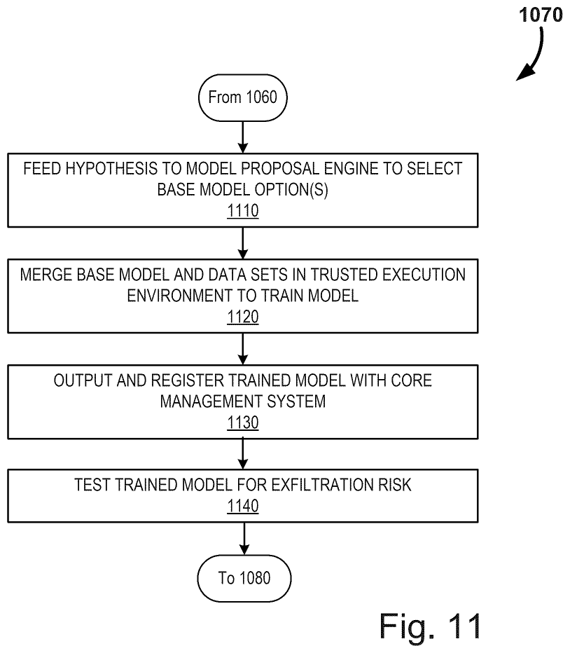

The next step in the process is to generate the model for the hypothesis, at 1060. FIG. 11 provides a more detailed description of this model creation sub-process. It starts by feeding the hypothesis to the model proposal engine to select base model options, at 1110. In some cases, the hypothesis (e.g., the type of outcome/conclusion/activity desired with the given data specification input) is fed to an AutoML engine for the selection of the base model options. There are many approaches to developing AI and Machine Learning algorithms from broader specifications. For example, many GenAI systems (for example, LLMs) can propose AI/ML models given a description of the problem and the data available for the training of the algorithm. Alternatively, there are data science tools and libraries that, when presented with input data and desired outcomes (labeled images, patient diagnoses or outcomes, credit risk scores, etc.) can automatically recommend one or more algorithms that can then be individually trained and assessed for prediction performance and generalizability. Any such approach could be used in conjunction with the hypothesis generation to produce one or more candidate algorithms for secure development in the platform.

The base model options and the data set are merged in a trusted computing environment for training activities, at 1120. In some embodiments, training iterations are guided by system or user prompts. For example, one might request that training be carried out for 10 training epochs (batches of training data presentation and model weight updates) in order to contain the computing cost or training time of a model early in the algorithm development process. In other cases, guidelines about the desired confidence levels and decision-making capability of a candidate model might be provided.

The trained model is then output and registered with the core management system, at 1130. The model may then be tested for exfiltration ability, at 1140. Exfiltration checks may include asking the model for sensitive data and checking its output, characterizing the outputs of the model under normal operations, and through statistical analysis of output data. For example, one approach would be to directly monitor the model output for PHI or PII (depending upon the business context of the model application and the data steward) and block or redact output as appropriate to the context. Another example would be to modify detailed output statistics to ensure that they are compliant with a privacy-protecting strategy such as K-Anonymity or Differential Privacy with a specific alpha parameter.

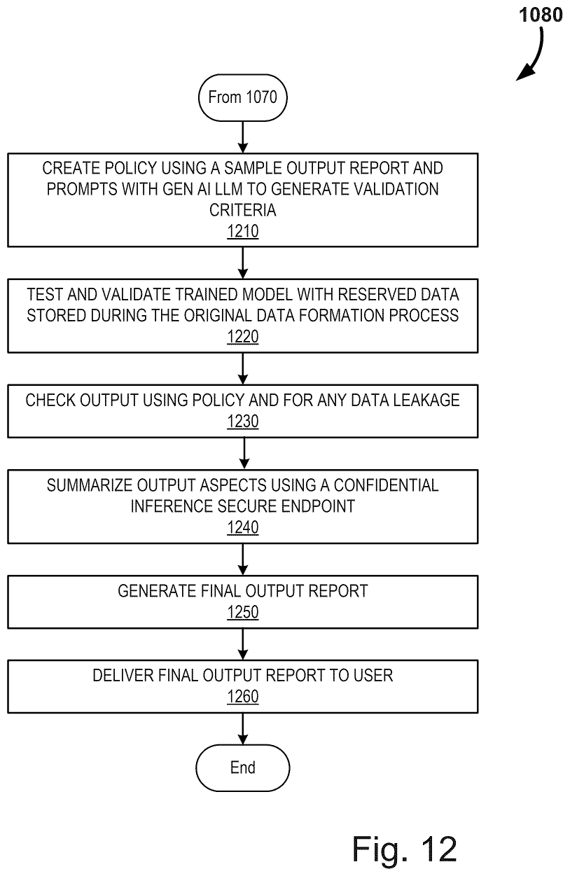

Returning to FIG. 10, after model training, the model may undergo a validation subprocess, at 1080 and as seen in greater detail in relation to FIG. 12. The hypothesis requires that the output is validated both to form and content using the validation criteria. Validation criteria is a policy creation process where the policy is generated autonomously using a sample output report and prompts to a generative AI Large Language Model (LLM), at 1210. Specifically the trained model may be tested and validated using the reserve data that was extracted in the earlier steps, at 1220. The output of the trained model after processing the reserve data is checked using the policy that was generated for any data leakage, and for output accuracy, at 1230. In some embodiments, a private AI is utilized for the validation checks.

Aspects of the output may be summarized using a confidential inference secure endpoint, at 1240, and provided back to a reporting engine prior to final sensitive information and policy checks. An output report is generated, at 1250, and delivered to the user, at 1260. If the trained model passes all policy and exfiltration checks, then it is also possible to deploy the newly generated model directly, or supply the mode back to the user for later deployment.

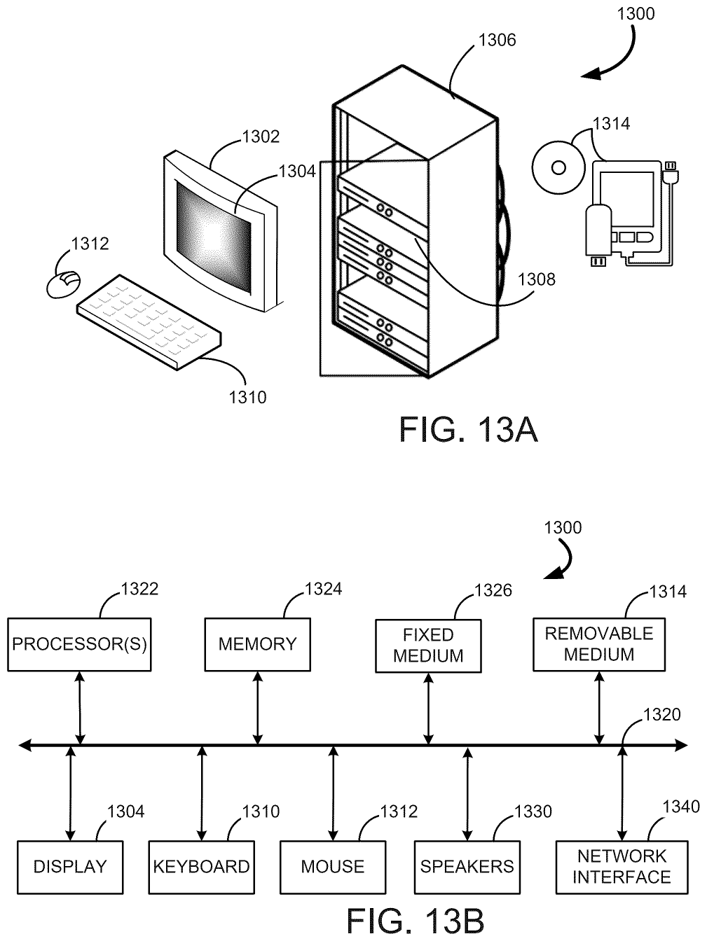

Now that the systems and methods for iterative project runtimes employing dynamic policies have been provided, attention shall now be focused upon apparatuses capable of executing the above functions in real-time. To facilitate this discussion, FIGS. 13A and 13B illustrate a Computer System 1300, which is suitable for implementing embodiments of the present invention. FIG. 13A shows one possible physical form of the Computer System 1300. Of course, the Computer System 1300 may have many physical forms ranging from a printed circuit board, an integrated circuit, and a small handheld device up to a huge supercomputer. Computer system 1300 may include a Monitor 1302, a Display 1304, a Housing 1306, server blades including one or more storage Drives 1308, a Keyboard 1310, and a Mouse 1312. Medium 1314 is a computer-readable medium used to transfer data to and from Computer System 1300. FIG. 13B is an example of a block diagram for Computer System 1300. Attached to System Bus 1320 are a wide variety of subsystems. Processor(s) 1322 (also referred to as central processing units, or CPUs) are coupled to storage devices, including Memory 1324. Memory 1324 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 1326 may also be coupled bi-directionally to the Processor 1322; it provides additional data storage capacity and may also include any of the computer-readable media described below. Fixed Medium 1326 may be used to store programs, data, and the like and is typically a secondary storage medium (such as a hard disk) that is slower than primary storage. It will be appreciated that the information retained within Fixed Medium 1326 may, in appropriate cases, be incorporated in standard fashion as virtual memory in Memory 1324. Removable Medium 1314 may take the form of any of the computer-readable media described below.

Processor 1322 is also coupled to a variety of input/output devices, such as Display 1304, Keyboard 1310, Mouse 1312 and Speakers 1330. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1322 optionally may be coupled to another computer or telecommunications network using Network Interface 1340. With such a Network Interface 1340, it is contemplated that the Processor 1322 might receive information from the network, or might output information to the network in the course of performing the above-described automated hypothesis generation. Furthermore, method embodiments of the present invention may execute solely upon Processor 1322 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1300 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a zero-trust computing environment, a computerized method for hypothesis generation, the method comprising:
inputting at least one research paper or study;
mine the at least one research paper or study for a set of data requirements;
combine the set of data requirements with a tailored prompt into a generative artificial intelligence (AI) system to generate a data specification;
within a secure enclave, combine the data specification with natural language (NL) prompts to interrogate data sets from a plurality of data stewards;
select a data set from the interrogated data sets that meets the data specification;
encrypt the data set;
generate an AI model; and
train the AI model on the data set.

2. The method of claim 1, wherein the AI model is generated by feeding a hypothesis into a model proposal engine to supply base model options.

3. The method of claim 2, wherein the AI model is generated by further merging the base model and the data set in a trusted execution environment to train the model.

4. The method of claim 1, further comprising outputting the trained AI model to a core management system for registration.

5. The method of claim 1, further comprising testing the trained AI model for exfiltration risks.

6. The method of claim 1, further comprising validating the trained AI model.

7. The method of claim 6, wherein the validating includes creating a policy using a sample output report and prompts using an generative AI large language model (LLM) to generate a set of validation criteria.

8. The method of claim 7, further comprising generating a set of reserve data during the data set selection process.

9. The method of claim 8, further comprising testing the trained AI model with the reserve data and checking for data leakage.

10. The method of claim 9, further comprising generating an output summary report for the validated AI model in a confidential inference secure endpoint.

11. In a zero-trust computing environment, a computerized system for hypothesis generation, the system comprising:
a datastore for inputting at least one research paper or study;
a first processor for mining the at least one research paper or study for a set of data requirements, combining the set of data requirements with a tailored prompt into a generative artificial intelligence (AI) system to generate a data specification; and
within a secure enclave, a server for combining the data specification with natural language (NL) prompts to interrogate data sets from a plurality of data stewards, selecting a data set from the interrogated data sets that meets the data specification, encrypting the data set, generating an AI model, and training the AI model on the data set.

12. The system of claim 11, wherein the AI model is generated by feeding a hypothesis into a model proposal engine to supply base model options.

13. The system of claim 12, wherein the AI model is generated by further merging the base model and the data set in a trusted execution environment to train the model.

14. The system of claim 11, further comprising a core management system to which the trained AI model is received and registered.

15. The system of claim 11, the core management system configured for testing the trained AI model for exfiltration risks.

16. The system of claim 11, wherein the core management system configured for validating the trained AI model.

17. The system of claim 16, wherein the validating includes creating a policy using a sample output report and prompts using an generative AI large language model (LLM) to generate a set of validation criteria.

18. The system of claim 17, wherein the secure enclave further configured for generating a set of reserve data during the data set selection process.

19. The system of claim 18, wherein the secure enclave further configured for testing the trained AI model with the reserve data and checking for data leakage.

20. The system of claim 19, wherein the secure enclave further configured for generating an output summary report for the validated AI model in a confidential inference secure endpoint.
